(19) United States
(12) Patent Application Publication
(10) Pub. No.: US 2025/0105423 A1
(43) Pub. Date: Mar. 27, 2025

(54) ELECTRIC BATTERY HOUSING AND ASSOCIATED ASSEMBLY METHOD

(71) Applicant: AUTOMOTIVE CELLS COMPANY SE, Bruges (FR)

(72) Inventors: Johan BAYLAC, Bordeaux (FR); Remy LAPORTE, Ambarès-et-Lagrave (FR); Teddy DE SILVA, Bordeaux (FR); Antoine SIMONIN, Mérignac (FR)

(73) Assignee: AUTOMOTIVE CELLS COMPANY SE, Bruges (FR)

(21) Appl. No.: 18/899,253

(22) Filed: Sep. 27, 2024

(30) Foreign Application Priority Data
Sep. 27, 2023 (EP) 23306610.9

(51) Int. Cl. H01M 50/262; H01M 50/209; H01M 50/271

(52) U.S. Cl. CPC H01M 50/262; H01M 50/209; H01M 50/271

(57) ABSTRACT

The invention relates to a housing for an electric battery, the housing includes two components, namely a support for a prismatic cell assembly, and a cover for covering the prismatic cell assembly. The locking system includes a lever attached to a first of the two components and rotationally guided relative to the first of the two components between a locked position and an unlocked position, and which, in the locked position, is elastically deformed so as to wedge itself into hooking means integral with the first of the two components, and come to bear against a surface of the second of the two components, ensuring that the two components are joined together.

### CROSS-REFERENCE TO RELATED APPLICATIONS

This application claims priority under 35 U.S.C. 119 to European Patent Application No. 23306610.9, filed Sep. 27, 2024; the disclosure of which is incorporated herein by reference in its entirety.

### TECHNICAL FIELD OF THE INVENTION

The invention relates to a housing for a module of an electric battery, in particular a module of a prismatic battery dedicated to supplying power to the drivetrain of an electric or hybrid motor vehicle, and to the assembly method associated with such a housing.

### STATE OF THE ART

Motor vehicles with electric or hybrid traction or propulsion comprise one or more battery packs connected to a power network for powering one or more electric (traction or propulsion) motors.

The term “battery pack” refers to a mechanical assembly of several battery modules. A battery module is a set of electrochemical cells, such as prismatic cells, electrically connected to each other. The battery pack generally comprises, in addition to the modules, a body accommodating the module(s) and a cover covering the body, the cover and body forming a rigid housing for keeping the cells of the module(s) compressed together and protecting them from external elements. To close the housing hermetically, the cover is usually screwed or glued to the body.

Thus, document CN212934743U discloses a battery pack composed of a top cover, a shell arranged at the bottom of the top cover, a battery unit arranged in the shell, a plurality of second connecting plates arranged at both ends of the top of the shell, and a plurality of first connecting plates arranged at both ends of the bottom of the top cover. A connection block is arranged at the bottom of each first connection plate, an insertion column is arranged at the bottom of each connection block, a connection groove is formed in each second connection plate and adapted to the corresponding connection block in an insertion mode, a second through-hole for a screw is formed in each second connection plate, and a third through-hole for a screw hole is formed in the side wall of each connection groove. Each connection block is provided with a first through-hole for a screw, and after inserting the top cover into the connection groove in the second connection plate through the connection block and the insertion column at the bottom of the first connection plate, the top cover is secured with the screw holes using locking bolts, so that the connecting and securing effect of the top cover body is achieved.

However, when assembling battery packs on a production line, connecting the connecting elements, making the through-holes and then screwing in the locking bolts can be long and tedious operations that slow down production. What's more, the presence of two locking systems (form-fit and screw-type) can complicate disassembly of the battery pack.

### DISCLOSURE OF THE INVENTION

The aim of the invention is to remedy the disadvantages of the prior art and to offer a battery housing that is easier to assemble and disassemble.

According to a first aspect of the invention, a housing for an electric battery is proposed, the housing comprising: two components, consisting of a support for a prismatic cell assembly, and a cover designed to cover the prismatic cell assembly; and a locking system that can be moved between a locked position and an unlocked position and, in the locked position, secures the two components together. The locking system of the housing comprises a lever attached to a first of the two components and rotationally guided relative to the first of the two components between the locked position and the unlocked position, and which, in the locked position, is elastically deformed so as to wedge itself into hooking means integral with the first of the two components, and come to bear against a surface of the second of the two components, ensuring that the two components are joined together.

The use of a locking system comprising a lever to secure the two components together eliminates the need for glue and/or screws and simplifies assembly and disassembly of the battery housing. Assembly time for both components is also reduced.

The prismatic cell assembly is a compact structure of prismatic cells electrically connected to each other in series or parallel, forming a rectangular parallelepiped.

According to one embodiment, the cover has at least one bottom wall facing and spaced from the support and two side walls projecting from the bottom wall and coming into contact with the support. If required, the support can comprise a flat plate with dimensions greater than the rectangular base of the prismatic cell assembly.

The cover is dimensioned to cover the top face of the cell assembly and at least partially cover two opposite side faces of the cell assembly.

Such a battery housing is adaptable to a plurality of prismatic cell sizes. In particular, the spatial dimensions of the housing in the locked position are such that:
the distance between the bottom wall and the support is greater than 80 mm, and preferably less than 150 mm; and/or
the distance between the two side walls is greater than 1500 mm and preferably less than 3500 mm; and/or
the bottom wall has a width, measured parallel to the side walls, greater than 500 mm and preferably less than 1500 mm; and/or
the two components in locked position delimit an internal volume greater than 0.06 m³ and preferably less than 0.8 m³.

According to one embodiment, the lever comprises a middle section rotationally guided by bearings formed on the first of the two components, about an axis of rotation, and at least one arm extending from the middle section in a radial direction with respect to the axis of rotation. Preferably, the lever has two parallel arms, preferably on either side of the middle section. In the unlocked position, the lever arm(s) can rotate around the middle section; in the locked position, the lever arm(s) is/are inserted in the hooking means of the first of the two components and the middle section presses against the surface of the second of the two components. The bearings are preferably plain.

The hooking means of the lever are attached to the first of the two components. In another embodiment, the hooking means are formed directly on the first of the two components.

In one embodiment, the hooking means comprise at least one recess formed in the first of the two components. The recess accommodates and holds the lever arms in position when locked. In one embodiment, the hooking means contain four hemi-cylindrical fasteners into which the lever is inserted.

In the locked position, the lever presses against the surface of the second of the two components, applying a predetermined locking force. The predetermined locking force is preferably between 100 N and 1000 N. Preferably, the locking force is applied mechanically at an assembly station. Alternatively, the locking force is applied manually.

In one embodiment, both components are at least partly made of insulating material(s). At least the material of the component intended to cover the prismatic cell assembly is an electrical insulator. Furthermore, the materials used in both components can withstand high pressures (9 bar, or 9.10⁵ Pa). Finally, the materials of both components remain elastically deformable when the housing is subjected to maximum stress.

In one embodiment, the housing comprises a fastening assembly comprising one or more projecting elements formed on one of the two components, abutting against one or more stop elements formed on the other of the two components, the fastening assembly holding the two components in a form-fitting locked position. The fastening assembly allows for the rotation of the component intended to cover the cell assembly relative to the component supporting the cell assembly, in order to move the battery housing from an open configuration to a closed configuration before locking it.

In a preferred embodiment, the projecting element(s) include(s) one or more fastening lugs and the stop element(s) comprise(s) one or more holes complementary to the fastening lugs.

According to another aspect of the invention, it relates to a method for assembling an electric battery housing as described above, comprising at least the following steps:
placing a prismatic cell assembly on the support;
covering the prismatic cell assembly with the cover, until the two components are in contact with each other;
toggling the locking system from the unlocked to the locked position to secure the two components together.

Preferably, the method further comprises the following step before toggling the locking system:
engaging the protruding element(s) of one of the two components into the stop element(s) of the other of the two components.

In a preferred embodiment, the assembly method is fully automated, which increases the speed of housing production. In another embodiment, the method is partially or entirely manual.

### BRIEF DESCRIPTION OF THE FIGURES

Other features and advantages of the invention will become apparent on reading the following description, with reference to the appended figures that follow:

FIG. 1 shows an exploded view of a battery housing according to a first embodiment;

FIG. 2 shows a general view of the battery housing in an unlocked position, according to the first embodiment;

FIG. 3 shows a general view of the battery housing in a locked position, according to the first embodiment.

For greater clarity, identical or similar elements are identified by identical reference signs in all of the Figures.

### DETAILED DESCRIPTION OF EMBODIMENTS

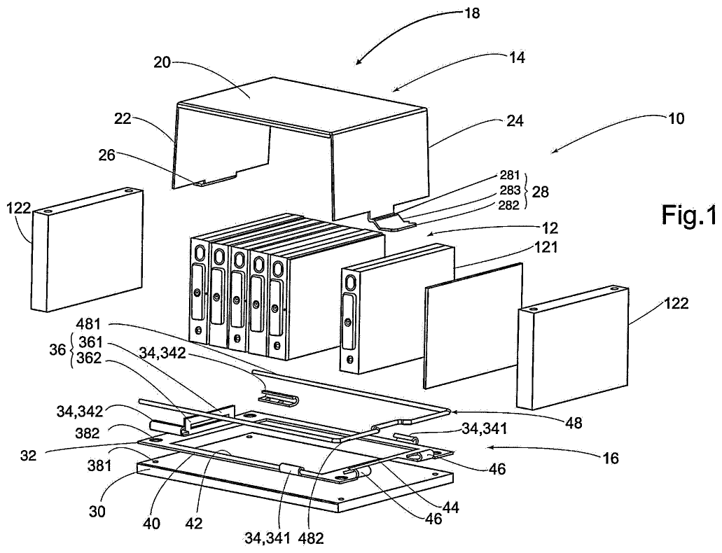

FIG. 1 shows a battery housing 10 accommodating a prismatic cell assembly 12 and comprising a first component 14 and a second component 16.

The prismatic cell assembly 12 is a compact serial or parallel structure of prismatic cells 121 forming a rectangular parallelepiped. At the two longitudinal ends of the cell assembly are protective walls 122 for mechanically holding the prismatic cell assembly 12.

In this embodiment, the first component 14 of the battery housing 10 is a cover 18, preferably metal, obtained for example by bending a plate or molding, and intended to at least partially cover the cell assembly 12.

As shown in FIG. 1, the cover 18 is U-shaped, open towards the second component 16 of the housing 10. It comprises a bottom wall 20, connecting a first side wall 22 and a second side wall 24. The length of the bottom wall 20 is preferably greater than the length of the first side wall 22 and the length of the second side wall 24, and the width of the bottom wall 20 is preferably equal to the width of the first side wall 22 and the width of the second side wall 24.

The bottom wall 20, the first side wall 22 and the second side wall 24 are made of metal material(s), for example aluminum, and at least partially covered with insulating material(s).

The bottom wall 20 of the cover 18 is designed to cover the upper face of the cell assembly 12, while the first and second side walls (22, 24) of the cover 18 are designed to partially cover the two outer faces of the protective walls 122 of the cell assembly 12.

At the end of the first side wall 22 of the cover 18 facing the second component 16 of the housing 10 are protruding elements 26 formed by two fastening lugs (261, 262) perpendicular to the side wall 22 of the cover 18.

At the end of the second side wall 24 of the cover 18 facing the second component 16 of the housing 10 is a stepped bearing surface 28, consisting of a first surface 281, a second surface 282, and a connecting surface 283. The first and second surfaces (281, 282) are parallel to each other and perpendicular to the second sidewall 24, while the intermediate surface 283 is oblique and connects the first surface 281 to the second surface 282. The stepped bearing surface 28 is plastically deformable.

The second component 16 of the battery housing 10 forms a support for the prismatic cell assembly 12 and comprises a flat plate 30 and a frame 32 on which hooking means 34 and a stop element 36 are formed/fastened.

The flat plate 30 is a rectangular plate, with a length and width greater than the length and width of the prismatic cell assembly 12. Preferably, the flat plate 30 is coated with an electrical insulator. Threaded holes 381 are drilled at all four ends of the flat plate.

The frame 32 of the second component 16 is obtained by stamping. It has an outer casing 40 and a hole 42 drilled through its center. The hole 42 is a rectangular through-hole, with a length and width equal to the length and width of prismatic cell assembly 12. The outer casing 40 is formed in two lengths equal to the lengths of the flat plate 30 and each comprising a flank of material 341 facing outwards from the hole 42, a width equal to the width of the flat plate 30 and a width comprising a rectangular material cutout 44 facing the rectangular through-hole 42. At the ends of the material cutout 44, the material of the frame 32 is deformed to form two open guide bearings 46, with the opening facing the rectangular through-hole 42. At the four ends of the frame, through-holes 382 are drilled, aligned with the tapped holes 381 in the flat plate 40 and enabling the frame 32 to be screwed to the plate 40.

According to the embodiment shown, the hooking means 34 are formed on both lengths of the outer casing 40 of the frame 32, the hooking means 34 comprising two hooks 341 formed by the deformation of the two flanks of material, and two notches 342 machined separately and attached to the frame 32.

The stop element 36 is attached to the width of the frame 32 facing the width with the material cutout 44. As shown in FIG. 1, the stop element 36 is a rectangular lamella 361 comprising a lumen 362 (insertion hole) at its center.

Finally, the battery housing 10 comprises a lever 48 with two perpendicular arms 481 connected by a central section 482. The middle section 482 of the lever 48 is inserted into the guide bearings 46 of the frame 32 of the second component 16, so as to make the lever 48 rotatable about the middle section 482 and move the battery housing 10 from an unlocked to a locked position.

The middle section 482 of the lever is deformed at its center to form a protrusion, so that in the unlocked position, the protrusion is at a distance from the stepped bearing surface 28, and in the locked position, the protruding wall exerts pressure on the bearing surface 28, in particular on the intermediate surface 283 of the bearing surface 28 to ensure hermetic locking of the housing 10.

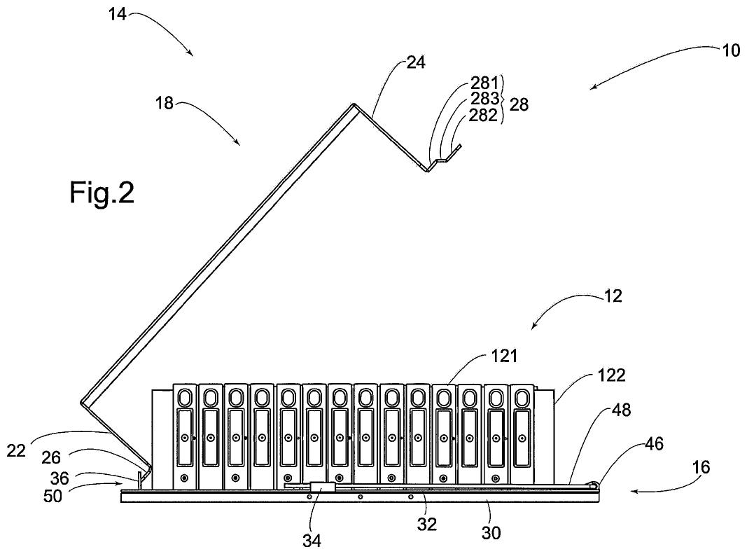

FIG. 2 shows the battery housing 10 in an unlocked position. The first and second components (14, 16) are held in contact by a fastening element 50, the fastening element being formed by the engagement of fastening lugs (261, 262) of the first component 14 in a slot 362 of the second component 16. The fastening element 50 allows the first component 14 to rotate relative to the second component 16.

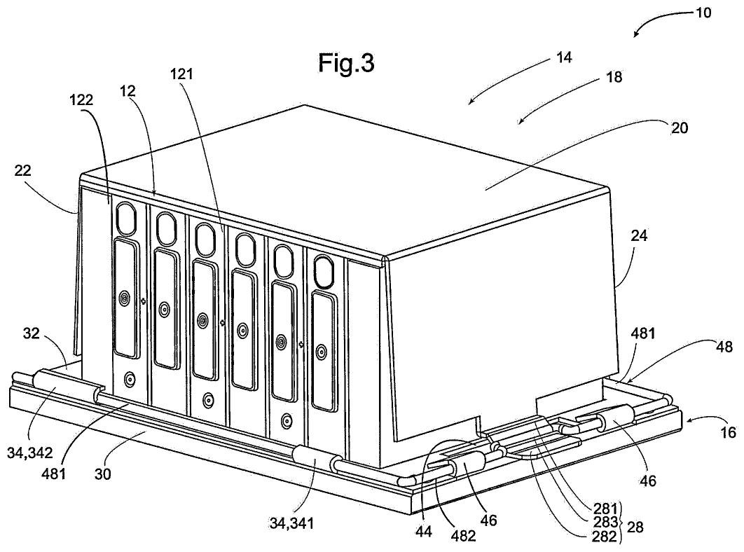

FIG. 3 shows the battery housing 10 in a locked configuration. In this configuration, the two components (14, 16) are fastened on one side by the fastening element 50, and on the other by the lever lock 48. The lever arms 481 engaged in the hooking means 34 of the second component 16 and the middle section 482 of the lever elastically deform the bearing surface 28 of the second component 16. The pressure applied by lever 48 on bearing surface 28 induces a concave curvature of the bottom wall 20 of the cover 18 of the first component 14. The maximum displacement of the bottom wall 20 of the cover 18 is located at its center and remains below the elastic limit.

According to an embodiment not shown, the fastening element 50 of the housing 10 comprises a projecting element 26 integral with the second component 16 and engaging in a stop element 36 fastened to the first component 14. In a further embodiment, the fastening element 50 is formed by a projecting element 26 of the first component 14 engaging in a projecting element 26 of the second component 16, for example a first hook fastened to the first component 14 engaging a second hook perpendicular to the first hook and fastened to the second component 16.

In an embodiment not shown, all hooking means 34 are formed directly on the frame 32 of the second component 16, the hooking means 34 being obtained by deforming material flanks 341 of the frame 32. In a further embodiment not shown, the hooking means 34 and the stop element 36 are attached directly to the plate 30 of the second component 16, the second component 16 having no frame 32.

Naturally, the examples shown in the figures and discussed above are provided for illustrative and non-limiting purposes only. It is explicitly provided that it is possible to combine the various illustrated embodiments in order to provide others.

In a variant not shown, the protruding elements 26 and the bearing surface 28 are formed on the second component 16, and the hooking means 34, the stop element 36 and the guide bearings 46 are fastened to the first component 14. In the same variant, the lever 48 is inserted on the first component 14 and comes into contact with the bearing surface 28 of the second component 16. The various embodiments described above can also be applied to this variant.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A housing for an electric battery, the housing comprising:
two components consisting of a support for a prismatic cell assembly and a cover for covering the prismatic cell assembly; and
a locking system which can be moved between a locked position and an unlocked position and, in the locked position, ensures that the two components are rigidly connected,
wherein the locking system comprises a lever attached to a first of the two components and rotationally guided relative to the first of the two components between the locked position and the unlocked position, and which, in the locked position, the lever is configured to elastically deform, configured to wedge into hooking means integral with the first of the two components, and come to bear against a surface of the second of the two components, to form a rigid connection between the two components.

2. The electric battery housing, according to claim 1, wherein the cover has at least one bottom wall located facing and spaced from the support and two side walls projecting from the bottom wall and coming into contact with the support.

3. The electric battery housing according to claim 1, wherein the lever comprises a middle section rotationally guided by bearings formed on the first of the two components, about an axis of rotation, and at least one arm extending from the middle section in a radial direction with respect to the axis of rotation.

4. The electric battery housing, according to claim 1, wherein the hooking means comprise at least one recess formed in the first of the two components.

5. The electric battery housing according to claim 1, wherein, in the locked position, the lever presses against the surface of the second of the two components and is configured to apply—a predetermined locking force.

6. The electric battery housing according to claim 1, wherein the two components are at least partly made of insulating material(s).

7. The electric battery housing according to claim 1, further comprising a fastening assembly comprising one or more projecting elements formed on one of the two components, abutting against one or more stop elements formed on the other of the two components, the fastening assembly configured to hold the two components in a form-fitting locked position.

8. The electric battery housing, according to claim 7, wherein the projecting element(s) include(s) one or more fastening lugs and the stop element(s) comprise(s) one or more holes complementary to the fastening lugs.

9. A method for assembling an electric battery housing, the electric battery housing comprising:
two components consisting of a support for a prismatic cell assembly and a cover for covering the prismatic cell assembly; and
a locking system which can be moved between a locked position and an unlocked position and, in the locked position, ensures that the two components are rigidly connected,
wherein the locking system comprises a lever attached to a first of the two components and rotationally guided relative to the first of the two components between the locked position and the unlocked position, and which, in the locked position, the lever is configured to elastically deform, configured to wedge into hooking means integral with the first of the two components, and come to bear against a surface of the second of the two components, to form a rigid connection between the two components,
wherein the method comprises the following steps:
placing a prismatic cell assembly on the support;
covering the prismatic cell assembly with the cover, until the two components are in contact with each other;
toggling the locking system from the unlocked to the locked position to secure the two components together.

10. The method according to claim 9 for assembling the electric battery housing, wherein the electric battery housing further comprises a fastening assembly comprising one or more projecting elements formed on one of the two components, abutting against one or more stop elements formed on the other of the two components, the fastening assembly configured to hold the two components in a form-fitting locked position,
wherein the method further comprises, before toggling the locking system, the following step:
engaging the protruding element(s) of one of the two components into the stop element(s) of the other of the two components.
